(19) United States
(12) Patent Application Publication
(10) Pub. No.: US 2009/0215436 A1
(43) Pub. Date: Aug. 27, 2009

(54) Integrated Wireless Mobile Media System

(75) Inventors: Kevin B. Howard, Laguna Niguel, CA (US); Kurtis Van Horn, Newport Coast, CA (US); Andrew Pinkman, Corona Del Mar, CA (US); David Hanrahan, San Jose, CA (US)

Correspondence Address: InTech IP Law Group, 1213 Avocet Ct., Cardiff by the Sea, CA, 92007, US

(73) Assignee: INTERNET CONNECTIVITY GROUP, INC., Lake Forest, CA (US)

(21) Appl. No.: 12/037,083

(22) Filed: Feb. 25, 2008

(51) Int. Cl. H04Q 7/22

(52) U.S. Cl. 455/414.3

(57) ABSTRACT

A fully integrated completely wireless mobile media system for digital signage applications receives content from a mobile telephone network. The received content is wirelessly distributed to point of sale locations and wireless local hotspots via IEEE 802.11(n) or later communications protocol. Audio and high definition video are streamed over MIMO RF technology incorporating JPEG2000 or later compression algorithms providing transmission quality up to or better than wired connectivity over a wireless link. The system requires no wired communications infrastructure such that the entire system may travel, or advertising displays are readily relocatable within the retail environment. Media content can be unicast for point to point (single endpoint) or multicast for multi-endpoint delivery. The system supports wireless local hotspot connectivity.

### BACKGROUND

I. Field

The presently disclosed embodiments relate generally to wireless communications, and more specifically to a completely integrated fully wireless mobile multi-media system.

II. Background

Digital signage is a form of out-of-home advertising in which content and multi-media messages displayed on an electronic screen, or digital sign, can be changed without modification to the physical sign, typically with the goal of delivering targeted messages to specific locations at specific times. Digital signage offers superior return on investment compared to traditional printed signs. The multi-media content displayed on digital signage screens can range from simple text and still images to full-motion video, with or without audio. Some operators of digital signage networks, particularly in the retail industry, regard their networks as comparable to television channels, displaying entertaining and informational content interspersed with advertisement.

Digital signage is used for many different purposes. Digital signage is commonly used to provide travelers with information such as flight information in airports and wait-times for the next train. Digital signage provides retailers with location related advertising and in-store promotions shown to uplift sales in retail establishments. Point of sale advertising and promotions, where the majority of purchase decisions are made, include automatic user coupon distribution and brand specific audio and video advertising.

Digital signage is used as a mechanism for advertising by third parties, or digital advertising companies, that sell advertising space to local merchants, service providers, media resellers and national advertisers. Digital signage applications are employed to enhance customer experience. Examples of customer experience enhancement include digital signage in restaurant waiting areas to reduce perceived wait-time, recipe demonstrations in food stores, entertainment while pumping gas and so forth.

Other signage applications include the influencing of customer behavior. Examples of customer behavior influence are post office digital signage that directs patrons waiting in line to automated stamp machines and retail digital signage designed to direct customers to different areas of the store, increasing the time spent on the store premises (dwell time). Digital signage is commonly used for brand building, such as Niketown stores where digital signage in video form is used as a part of the store decor to build a story around the brand. Digital signage is also used for collecting follow through campaign information for store managers and increasing the customer experience with the building itself.

Digital signs may be scrolling message boards, LCD or plasma display panels, electronic billboards, projection screens, or other emerging display types like living surfaces or Organic LED screens (OLEDs) that can be controlled electronically using a computer or other devices, allowing individuals or groups to remotely change and control their content (usually via the Internet). Rapidly-dropping prices for large plasma and LCD screens and wide availability of Internet connectivity have caused digital signage deployments to gain in popularity, and displays can now be found in such diverse locations as retail outlets, transit hubs (like airports or bus stations), doctor's offices, fast food restaurants and even gas stations. The recent introduction of free digital signage software will further expand the “pool” of potential users of this technology. It will now be attractive to smaller businesses (that may have otherwise found this technology too expensive), as well as to “non-profits” such as schools, universities and churches, rather than only to large companies that spend billions yearly to present their consumer advertisements.

Multi-media content scheduling and playback can be controlled by a number of technologies ranging from simple, non-networked media players that output basic loops of MPEG-2 video to complex, N-tier player networks that offer control over multiple displays in many venues from a single location. The former is ideal for small groups of displays that can be updated via sneaker net (the practice of physically transporting data to each location on a disc or CD-ROM, usually by walking), while the latter allows Digital Signage Network Operators to either push content to many players at once or have each player pull content from a server as needed.

Traditional digital signage systems are typically television monitors, or displays, distributed throughout high traffic areas or point of sale locations at a business site on a Local Area Network (LAN). These networked displays are typically Ethernet coupled to an on site local network server, which transfers advertising content to the displays. The server may be configured to receive advertisement information from the Internet or a hard storage media such as hard disk, floppy disk, optical disk, magnetic tape, etc.

Unfortunately, these traditional systems are immobile and overly costly. Traditional systems normally require wiring for Internet access and networking, hard line connections, and media players and memory storage devices at every display unit. Maintaining a LAN at a business site is often cost prohibitive for small businesses. Not only is the cost of using and maintaining a LAN relatively high, traditional systems can neither be easily moved from their original sites nor reconfigured to accommodate on-site merchandise relocations.

While some advertising systems configured for point of sale use attempt to overcome these shortcomings, they are either only partially wireless, have no wireless Internet connectivity, or fail to deliver wire quality full stream audio and video using the latest technology. Thus, there is a need in the art for a turnkey media solution designed to provide a completely wireless end to end digital signage system, with Internet access, that is fully mobile.

### SUMMARY

Embodiments disclosed herein address the above-stated needs by providing a fully integrated completely wireless mobile media system for digital signage applications. The system receives content from a mobile telephone network. The received content is wirelessly distributed to point of sale locations and wireless local hotspots via IEEE 802.11(n) or later communications protocol. Audio and high definition video are streamed over MIMO RF technology incorporating JPEG2000 or later compression algorithms providing transmission quality up to or better than wired connectivity over a wireless link. The system requires no wired communications infrastructure such that the entire system may travel, or advertising displays are readily relocatable within the retail environment. Media content can be unicast for point to point (single endpoint) or multipoint delivery. The system also includes wireless local hotspot connectivity.

In one aspect, a wireless media system comprises an integrated wireless base unit for receiving media content from a mobile telephone network and transmitting the media content to designated endpoint receiver(s) using an IEEE 802.11(n) or later communication protocol and at least one wireless receiver for receiving the media content from the wireless base unit in an IEEE 802.11(n) or later communication protocol for input to a communicatively coupled endpoint.

In another aspect, a wireless media base unit comprises a cellular modem for receiving media content from a mobile telephone network, a controller for downloading, storing, sorting and scheduling transmission of the received media content, a Wireless Fidelity (WiFi) router for connectivity with wireless devices, and a 802.11(n) or later communication protocol capable adapter transmitter for compressing the received media content using a JPEG2000 or later format and transmitting the compressed media content to designated endpoint receivers.

In another aspect, a wireless media receiver comprises an 802.11(n) or later communications protocol capable embedded radio module for receiving compressed media content and an audio/video decompression module for decompressing the received media content for output to a designated communicatively coupled endpoint.

In another aspect, a wireless media transmitter comprises a video compression module for compressing media content and an 802.11(n) or later communications protocol capable embedded radio module for transmitting the compressed media content to a wireless media receiver.

In another aspect, a method for providing wireless media service comprises receiving and downloading media content from a mobile telephone network, sorting and forwarding the received media content to appropriate user applications, scheduling transmission of the sorted media content to designated endpoints, and transmitting the scheduled media content to at least one designated endpoint using an IEEE 802.11(n) or later communication protocol.

In yet another aspect, a computer-readable medium having instructions stored thereon to cause computers in a communication system to perform a method, the method comprises receiving and downloading media content from a mobile telephone network, sorting and forwarding the received media content to appropriate user applications, scheduling transmission of the sorted media content to designated endpoints, and transmitting the scheduled media content to at least one designated endpoint using an IEEE 802.11(n) or later communication protocol.

### BRIEF DESCRIPTION OF THE DRAWINGS

FIG. 1 (PRIOR ART) is a block diagram illustrating a traditional digital signage system;

FIG. 2 is a block diagram illustrating a high level overview of an exemplary integrated wireless Mobile Media System;

FIG. 3 is a block diagram illustrating a detailed example of an integrated wireless Mobile Media System base unit;

FIG. 4 is a block diagram illustrating a detailed example of a Mobile Media System base unit ViFi Adapter Transmitter component;

FIG. 5 is a block diagram illustrating a detailed example of a Mobile Media System base unit Controller component to ViFi Adapter Transmitter component interface;

FIG. 6 is a block diagram illustrating a detailed example of a ViFi Adapter Receiver system component; and

FIG. 7 is a flowchart illustrating steps of an exemplary method for providing integrated wireless mobile media service.

### DETAILED DESCRIPTION

The word “exemplary” is used exclusively herein to mean “serving as an example, instance, or illustration.” Any embodiment described herein as “exemplary” is not necessarily to be construed as preferred or advantageous over other embodiments.

The word “processor” is used herein to mean one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

The apparatus and methodology disclosed herein may be used in the context of various wireless networks such as a Code Division Multiple Access (CDMA) network, a Time Division Multiple Access (TDMA) network, a Frequency Division Multiple Access (FDMA) network, an Orthogonal Frequency Division Multiple Access (OFDMA) network, a network supporting a combination of the aforementioned technologies, a network with wide area network (WAN) coverage as well as wireless local area network (WLAN) coverage, or any other wireless networking scheme.

A CDMA network may implement one or more CDMA radio access technologies (RATs) such as Wideband CDMA (W-CDMA), cdma2000, or other CDMA RATs. Cdma2000 RAT comprises IS-2000, IS-856, and IS-95 standards incorporated herein by reference. A TDMA network may implement one or more TDMA RATs such as Global System for Mobile Communications (GSM), Digital Advanced Mobile Phone System (D-AMPS), or other TDMA RAT. D-AMPS RAT comprises IS-136 and IS-54 standards incorporated herein by reference. W-CDMA and GSM technical specifications are described in public “3rd Generation Partnership Project” (3GPP, or 3G) consortium documents. Cdma2000 technical specifications are described in public “3rd Generation Partnership Project 2” (3GPP2) consortium documents.

The present Integrated Wireless Mobile Media System is constructed to send and receive audio, video and data transmissions from wireless and wired infrastructures. This wireless analog and digital information is received stored, processed, encoded, compressed, and distributed via a wireless technology medium to both static and dynamic displays. The input signals can be via Cellular, WiFi and other wireless technologies with wired technology access as backup. The wireless carrier signal will be based on both open and closed source wireless technologies. These can include RF, UWB, Bluetooth, WiFi, and Cellular as well as new and emerging wireless technologies. These signals can be unicast for point to point (single point) or multipoint solutions. The solution also enables multicast; multiple data streams to multiple end points.

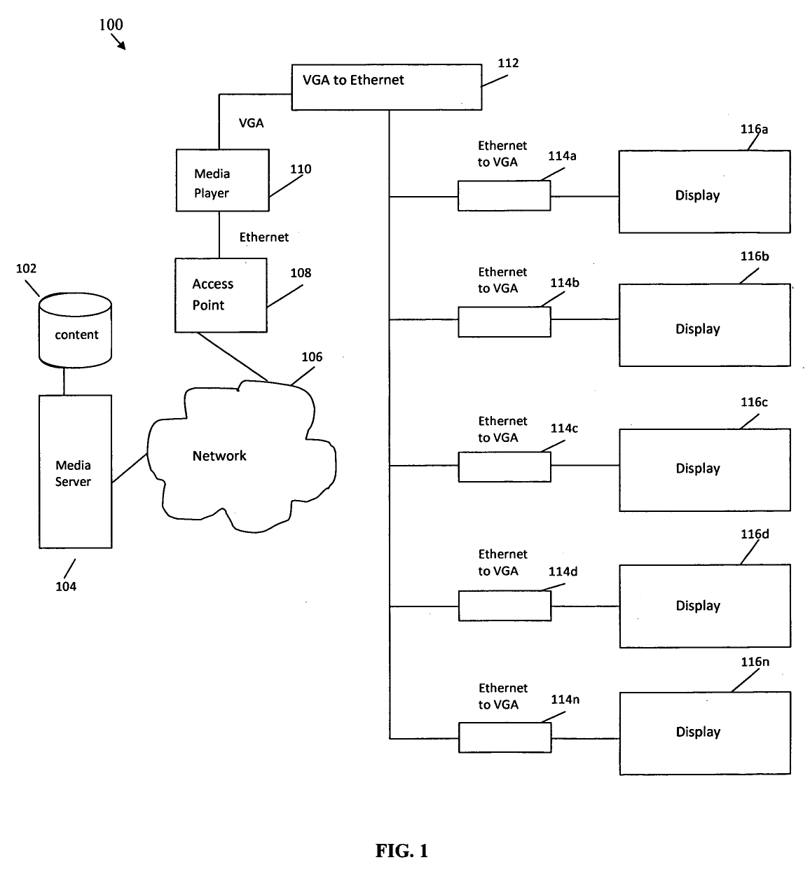

FIG. 1 is a simplified diagram illustrating typical digital signage system prior art 100. Advertising content from a storage device 102 is provided to a Communications Network 106 by Media Server 104. Communications Network 106 is shown, for illustrative purposes, as an off site Internet Service Provider (ISP). A business site Network Access Point 108 is configured to receive advertising content provided by the Media Server 104 for input to a local Media Player 110. The Media Player 110 outputs an analog Video Graphics Array (VGA) signal to a VGA to Ethernet converter 112 for distribution on the business site's LAN. The advertising content is transferred from the LAN to one or more Ethernet to VGA converters 114 associated with individual Displays 116 for customer presentation.

The business site must be permanently hard wired for Internet access and networking. Many business sites do not have the option to utilize existing landline communications or are unsuitable for network installations. Media players 110, converters 114, operating systems and memory storage devices are required for each Display 116. The required extraneous devices (108, 110, 112, 114) and business site LAN are costly to install and maintain. Furthermore, the hardwired Displays 116 are not readily relocatable within the retail environment where merchandise is often changed, moved, or redisplayed in a new or different manner. Likewise, the entire system cannot be relocated, for example, for use as traveling convention kiosks or a to new or expanded storefront, common carrier transportation, other mobile applications.

Variations of the traditional digital signage system of FIG. 1 are also known in the art. Some such systems are only partially wireless and therefore not fully mobile, require micro-computers and or other equipment at each display and are therefore not completely integrated, and/or employ low quality transmission methods for audio, video and data content.

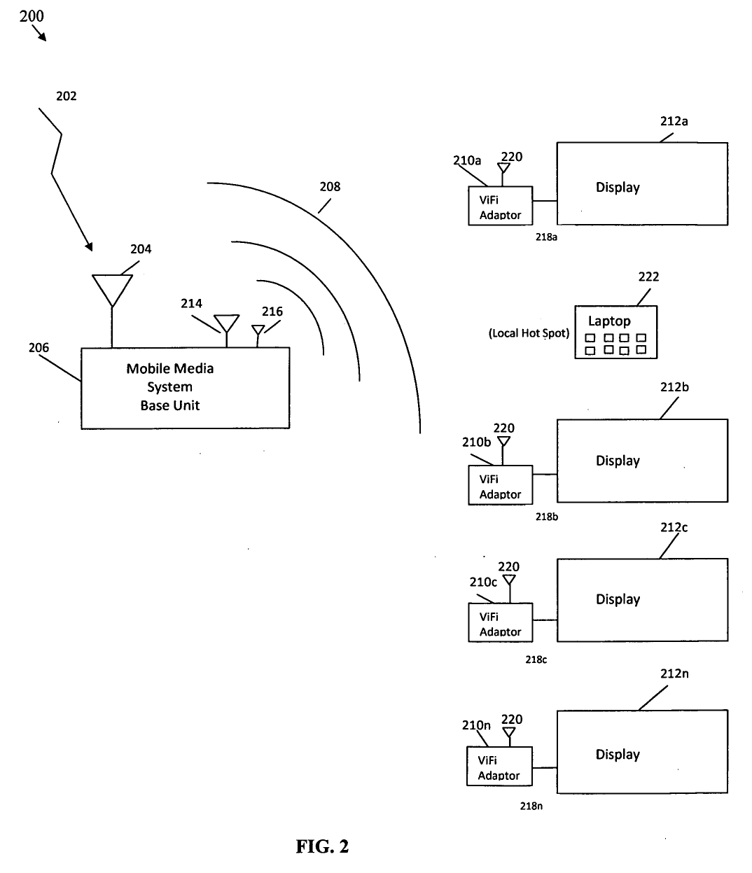

FIG. 2 is a block diagram illustrating a high level overview of an exemplary fully integrated completely wireless Mobile Media System 200. A Mobile Media System Base Unit 206 receives cellular communication signal 202 carrying multi-media content at cellular antenna 204. Mobile Media System Base Unit 206 stores, sorts and schedules the received content for transmission 208 from Video-over-WiFi (ViFi) Antenna 216 to individual ViFi Adapters 210, which are communicatively coupled 218 to an associated Display 212. Internet data signals are received and transmitted from WiFi Antenna 214 creating local wireless hotspot Internet connectivity for one or more Laptop or other computers 222 having a wireless modem. Cellular antennas 204, 214 and 216 may comprise a single or multiple antenna configuration.

WiFi is a wireless-technology brand owned by the WiFi Alliance, which promotes standards with the aim of improving the interoperability of wireless local area network products based on the IEEE 802.11 standards. Common applications for WiFi include Internet and VoIP phone access, gaming, and network connectivity for consumer electronics such as televisions, DVD players, and digital cameras. A WiFi-enabled device such as a PC, game console, cell phone, MP3 player or PDA can connect to the Internet when within range of a wireless network connected to the Internet. The coverage of one or more interconnected access points, called a hotspot, can comprise an area as small as a single room with wireless-opaque walls or as large as many square miles covered by overlapping access points. WiFi also allows connectivity in peer-to-peer (wireless ad-hoc network) mode, which enables devices to connect directly with each other. This connectivity mode can prove useful in consumer electronics and gaming applications. WiFi allows LANs to be deployed without cabling for client devices, typically reducing the costs of network deployment and expansion. Spaces where cables cannot be run, such as outdoor areas and historical buildings, can host wireless LANs.

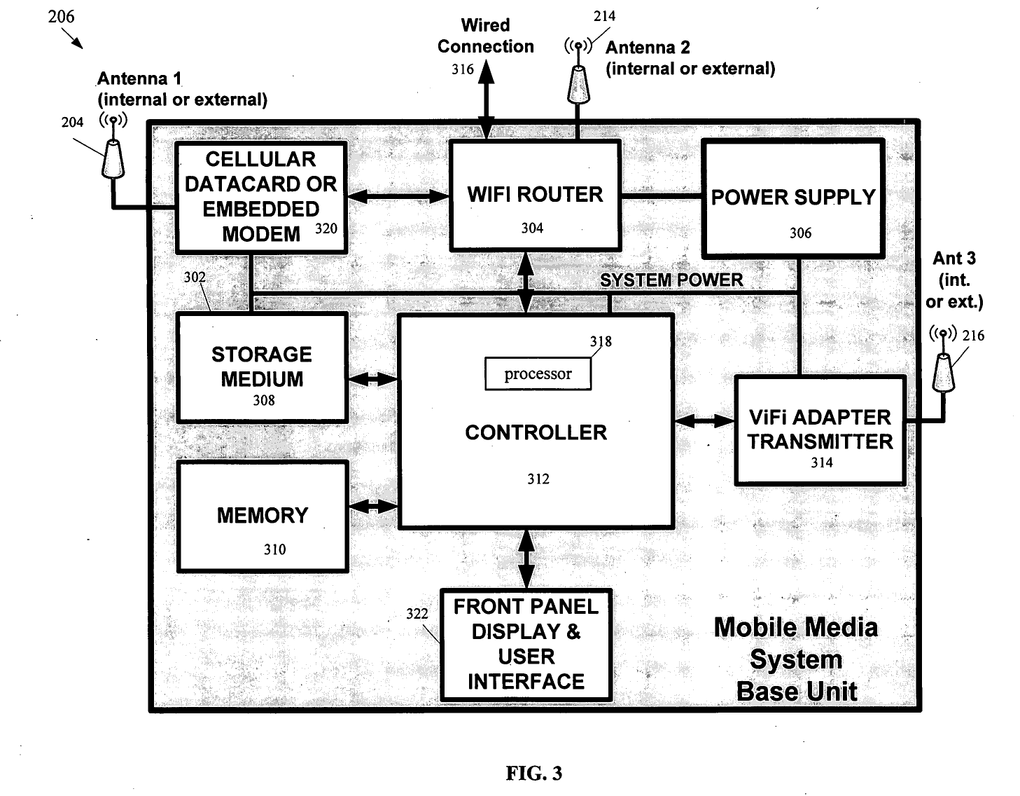

In one embodiment, the content and data communication protocol of the Mobile Media System Base Unit 206 is ViFi, utilizing the IEEE 802.11(n) standard. IEEE 802.11(n) is a proposed amendment which improves upon the previous 802.11 standards by adding Multiple-Input Multiple-Output (MIMO) and many other newer features including 40 MHz operation to the physical layer. MIMO uses multiple transmitter and receiver antenna configurations to improve the system performance. 40 MHz operation uses wider bandwidth (compared to 20 MHz bandwidth in legacy 802.11 operation) to support higher data rates. These higher data rates enable real time JPEG2000 video compression in concert with MIMO high definition video streaming, audio streaming by the Mobile Media System Base Unit 206. The Mobile Media System Base Unit 206 is detailed in FIG. 3.

FIG. 3 is a block diagram illustrating a detailed example of an integrated wireless Mobile Media System base unit 206. The Mobile Media System base unit 206 is designed to send and receive RF signals via a Third Generation (3G) cellular router or a wired back-up 316. The received content is downloaded to memory for layering, or application sorting, and scheduling. This information is then processed, encoded and compressed in real time during media playback. The encoded information is transmitted via a wireless technologies including but not limited to: Radio Frequency (RF), Ultra-wideband (UWB), Bluetooth, WiFi, and Cellular as well as new and emerging wireless technologies to designated display receivers.

Content and data are received via cellular Antenna 1 204 for processing by cellular modem 320. Cellular modem 320 may be an Application Specific Integrated Circuit (ASIC), cellular data card, embedded module, modem board, or any other means for receiving cellular radio access technologies. The received content may be stored on storage medium 308 or transmitted to one or more displays in real time. Storage medium 308 may comprise a hard disk drive, floppy disk, optical disk, magnetic tape, or any other storage medium known in the art.

Processor 318 based Controller 312, communicatively coupled to Cellular Modem 320, Storage Medium 308, Memory 310, WiFi Router 304, ViFi Adapter Transmitter 314 and Front Panel Display and User Interface 322 supports an operating system and user applications for sorting received content and scheduling display transmissions. Exemplary user applications executed by processor 318 include logo applications, point of sale advertising applications, point of sale promotions applications, games, entertainment, information applications or any digital signage application. Wi-Fi router 304 provides functionality for billable Wi-Fi services, content filtering, SMS/Short-code messaging, remote management and maintenance. Controller 312 supports media content and management software.

Front Panel Display and User Interface 322 provides a local interface enabling direct user access to user applications and content stored in Storage Medium 308. Users may locally modify and schedule content display and perform other managerial tasks without any external connectivity. Front Panel Display and User Interface 322 comprises pushbuttons for System Status Monitoring, and Control and Configuration. In one embodiment, the display is a 4-line alphanumeric display with pushbuttons for user control. In other embodiments, the Display 322 is a Graphics LCD, touch screen, OLED, etc.

Processor 318 operates according to executable instructions fetched from Memory 310. Memory 310 may be RAM memory, flash memory, ROM memory, EPROM memory, EEPROM memory, registers, a removable disk, a CD-ROM, or any other form of storage medium known in the art. Power to all Mobile Media System base unit 206 components is provided by Power Supply 306.

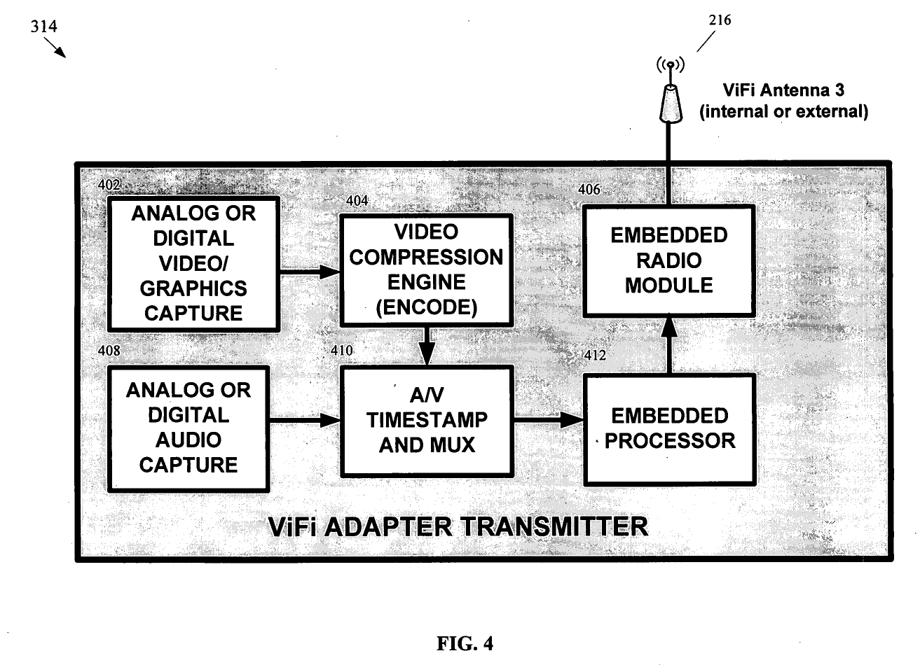

Content and data sorted and scheduled by Controller 312 are transmitted to system Displays by ViFi Adapter Transmitter 314 via Antenna 3 216 and to local wireless hot spot devices by WiFi Router 304 via Antenna 2 214. ViFi Adapter Transmitter 314 is detailed in FIG. 4.

In one embodiment, the Mobile Media System base unit 206 supports the following technical features:
802.11n Radio (WLAN) for transmitting High Definition (HD) quality audio/video or graphics by supporting approximately 100 Mbps transmission bandwidth within the 5 GHz radio frequency band.
Network Issued/DHCP IP Address assignment necessary to support multi-user web surfing and video content on display as well as for broadcasting same video to multiple displays connected to a single Mobile Media System.
3G Network Interface via Embedded WWAN Module
80+GB solid state hard drive Memory.
Linux or Microsoft based Operating System.
   It will be appreciated by those skilled in the art that various embodiments of the Mobile Media System base unit 206 may implement a variety of alternative technical features.

FIG. 4 is a block diagram illustrating a detailed example of a base unit ViFi Adapter Transmitter 314. ViFi Adapter Transmitter 314 enables cached High Definition (HD) audio/video or graphics content to be streamed over WiFi through multiple video outputs that enable displays on any monitor, TV, LCD, Panel Display or other viewing device. ViFi Adapter Transmitter 314 allows distribution of digital media content from one source to multiple monitors completely wirelessly utilizing 802.11(n) or later WiFi standards.

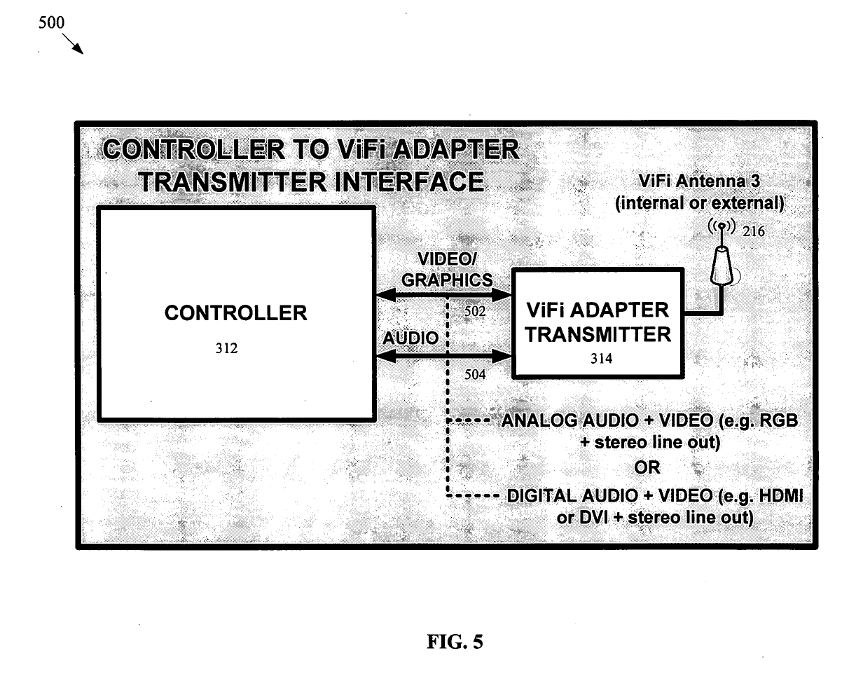

Analog or digital video provided by Controller 312 to Video/Graphics Capture Module 402 is encoded and compressed by Video Compression Engine 404 for time stamping and multiplexing by A/V Timestamp MUX Module 410. In one embodiment, JPEG2000 video compression is implemented by the Compression Engine 404 video encoding process. Analog or digital audio provided by Controller 312 is directly time stamped and multiplexed by A/V Timestamp MUX Module 410. The Controller 312 to ViFi Adapter Transmitter interface is detailed in FIG. 5.

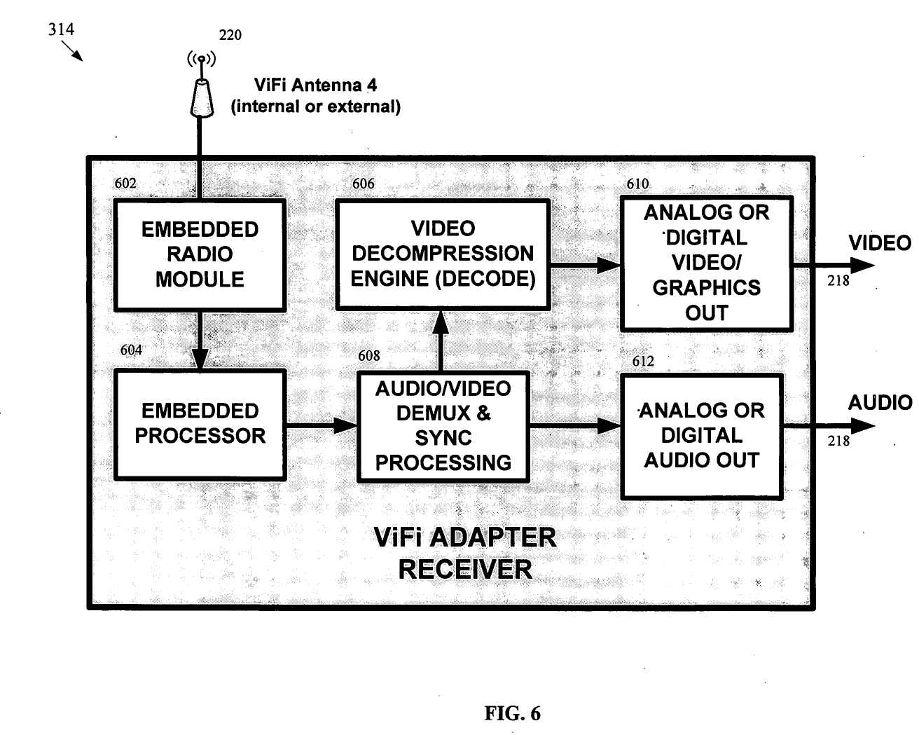

A/V Timestamp MUX Module 410 outputs time stamped and multiplexed audio and encoded video to embedded processor 412, which controls 802.11(n) or later standard transmission by embedded radio module 406 via Antenna 3 216. 802.11(n) Standard signals are received by one or more ViFi Adapter Receivers 314 associated with individual system Displays 212. The ViFi Adapter Receiver 314 is detailed in FIG. 6.

FIG. 5 is a block diagram illustrating a detailed example of a base unit Controller 312 to ViFi Adapter Transmitter 314 interface 500. Controller 312 and ViFi Adapter Transmitter 314 are communicatively coupled by Video/Graphics bus 502 and Audio bus 504. Video and Graphics information exchanged between Controller 312 and ViFi Adapter Transmitter 314 comprise analog audio and analog video (i.e. RGB) or digital audio and digital video (i.e. HDMI or DVI) or a combination of analog and digital outputs.

FIG. 6 is a block diagram illustrating a detailed example of a ViFi Adapter Receiver system component 314. Embedded Radio Module 602 receives encoded and compressed audio and video 802.11(n) or later standard streams from ViFi Adapter Transmitter 314 via ViFi Antenna 4 220, and converts the signals for processing by Embedded Processor 604. Cellular antenna 220 may be a single or multiple antenna configuration. Embedded Processor 604 outputs digitized audio and video signals to Demux and Sync Processing module 608, which synchronizes time stamp information and de-multiplexes video and audio into separate signals. The video portion of the received signal is then decompressed and decoded by Video Decompression Engine 606 for output 218 to a Display by Video/Graphics output module 610. The Audio portion of the received signal is output 218 to a Display by Audio output module 612.

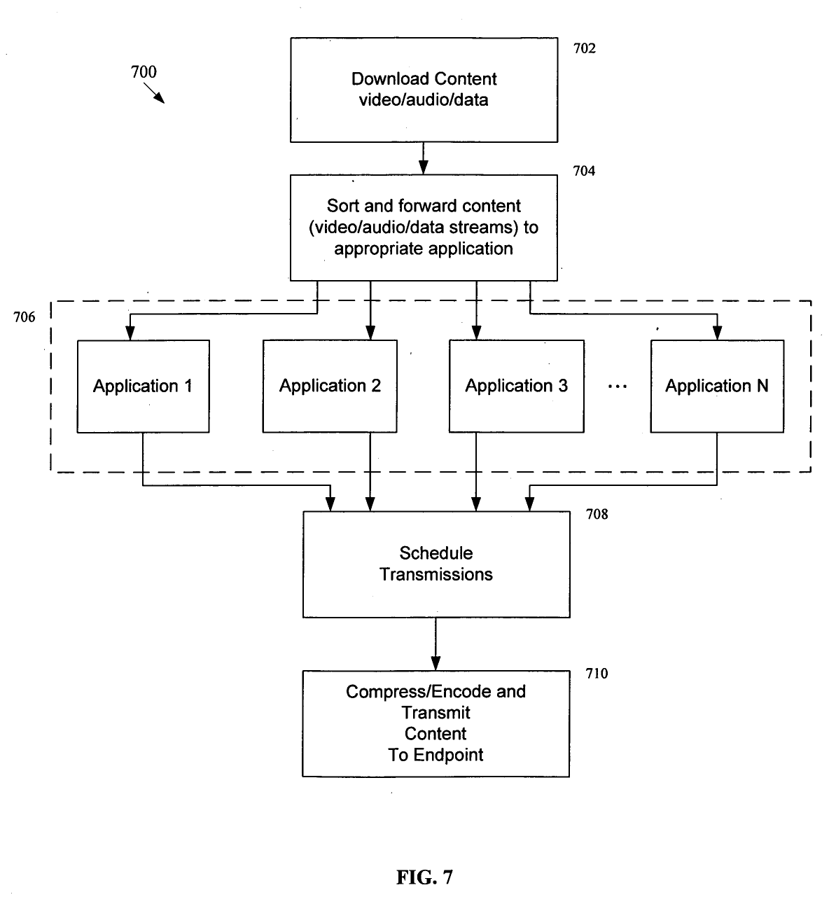

FIG. 7 is a flowchart illustrating steps of an exemplary method for providing integrated wireless mobile media service 700. Integrated wireless mobile media service allows completely wireless distribution of digital media content from one source to multiple monitors, thus providing multiple revenue channels per Mobile Media System as well as remote management and maintenance. Video content may be cached and scheduled for playback or delivered in real time. Content applications may include Ad-Injections and Persistent Banners, logos, games, news, entertainment, promotions or any other user specified application. The Mobile Media System is content agnostic—open to any of the various software technologies that content providers design with to create advertising and marketing messaging.

Processing begins in step 702 wherein a cellular signal having content is received and downloaded to the Mobile Media System. Control flow proceeds to step 704.

In step 704, the received content is stored and sorted for input to an appropriate application. Control flow proceeds to step 706.

In step 706, the sorted content is received and forwarded to one or more appropriate applications. For example, logo content may be forwarded to a first application, banner content a second application, advertisement forwarded to a third application and sound bites to another application. Content may also comprise Internet data designated for local wireless hotspot devices. When the sorted content has been input to and processed by the appropriate application, the application requests scheduling of its content for transmission to a designated display(s). Control flow proceeds to step 708.

In step 708, content is scheduled for transmission to a designated display or displays. Content may be scheduled for real time transmission or presentation from storage at a later time. Control flow proceeds to step 710.

In step 710, content is compressed, encoded and then transmitted to its designated endpoint. One skilled in the art will understand that ordering of steps illustrated in FIG. 7 is not limiting. The method is readily amended by omission or re-ordering of the steps illustrated without departing from the scope of the disclosed embodiments.

Thus, a novel and improved method and apparatus for an integrated wireless multimedia system have been described. Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a system base unit.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A wireless media system comprising:
an integrated wireless base unit for receiving media content from a mobile telephone network and transmitting the media content to designated endpoint receiver(s) using an IEEE 802.11(n) or later communication protocol; and
at least one wireless receiver for receiving the media content from the wireless base unit in an IEEE 802.11(n) or later communication protocol for input to a communicatively coupled endpoint.

2. The wireless media system of claim 1 wherein the wireless base unit comprises a 802.11(n) or later capable adapter transmitter for compressing the received media content using a JPEG2000 or later format and transmitting the compressed media content to at least one designated endpoint receiver.

3. The wireless media system of claim 1 wherein the endpoint is a display or wireless device.

4. The wireless media system of claim 1 wherein the wireless base unit comprises a controller for downloading, storing, sorting and scheduling transmission of the received media content.

5. The wireless media system of claim 1 wherein the wireless base unit comprises a Wireless Fidelity router for connectivity with wireless devices.

6. The wireless media system of claim 1 wherein the wireless base unit comprises a wired backup connection.

7. A wireless media base unit comprising:
a cellular modem for receiving media content from a mobile telephone network;
a controller for downloading, storing, sorting and scheduling transmission of the received media content;
a Wireless Fidelity router for connectivity with wireless devices; and
a 802.11(n) or later communication protocol capable adapter transmitter for compressing the received media content using a JPEG2000 or later format and transmitting the compressed media content to designated endpoint receivers.

8. The wireless media base unit of claim 7 wherein the Adapter Transmitter transmits High Definition (HD) quality audio/video/graphics by supporting up 100 Mbps over a 5 Ghz frequency band.

9. The wireless media base unit of claim 7 wherein Network Issued/DHCP IP Addresses necessary to provide simultaneous web surfing and video content on display as well as for broadcasting same video to multiple displays are connected to a single Mobile Media System.

10. The wireless media base unit of claim 7 further comprising a front panel display and user interface enabling a local user to modify and schedule content display, and perform other managerial tasks without any external connectivity.

11. The wireless media base unit of claim 7 wherein the Wireless Fidelity router comprises a 3G or later Wireless Network Interface via Embedded WWAN Module.

12. The wireless media base unit of claim 7 further comprising a 80+GB solid state hard drive memory.

13. The wireless media base unit of claim 7 wherein the controller supports a Linux or Microsoft based Operating System.

14. A wireless media receiver comprising:
an 802.11(n) or later communications protocol capable embedded radio module for receiving compressed media content; and
an audio/video/graphics decompression module for decompressing the received media content for output to a designated communicatively coupled endpoint.

15. The wireless media receiver of claim 8 wherein the video decompression module supports JPEG 2000 or later standard decompression algorithms.

16. A wireless media transmitter comprising:
an audio/video/graphics compression module for compressing media content; and
an 802.11(n) or later communications protocol capable embedded radio module for transmitting the compressed media content to a wireless media receiver.

17. The wireless media transmitter of claim 16 wherein the video compression module supports JPEG 2000 or later standard compression algorithms.

18. A method for providing wireless media service comprising:
receiving and downloading media content from a mobile telephone network;
sorting and forwarding the received media content to appropriate user applications;
scheduling transmission of the sorted media content to designated endpoints; and
transmitting the scheduled media content to at least one designated endpoint using an IEEE 802.11(n) or later communication protocol.

19. A computer-readable medium having instructions stored thereon to cause computers in a communication system to perform a method, the method comprising:
receiving and downloading media content from a mobile telephone network;
sorting and forwarding the received media content to appropriate user applications;
scheduling transmission of the sorted media content to designated endpoints; and
transmitting the scheduled media content to at least one designated endpoint using an IEEE 802.11(n) or later communication protocol.
